(19) United States
(12) Patent Application Publication
(10) Pub. No.: US 2017/0075048 A1
(43) Pub. Date: Mar. 16, 2017

(54) XENON SUPPRESSION FILTER FOR SPECTROMETRY

(71) Applicant: Ocean Optics, Inc., Dunedin, FL (US)

(72) Inventor: Paul W. Ave, Orlando, FL (US)

(21) Appl. No.: 15/244,434

(22) Filed: Aug. 23, 2016

Related U.S. Application Data
(60) Provisional application No. 62/217,078, filed on Sep. 11, 2015.

(51) Int. Cl. G02B 5/20; G01J 3/02

(52) U.S. Cl. CPC G02B 5/208; G01J 3/0229

(57) ABSTRACT

A device for improving the suppression of light from a Pulsed Xenon light source for spectrometry by combining a Variable Longpass Order-Sorting filter with a Dichroic Balancing filter coated on a fused Silica substrate is disclosed.

### CROSS-REFERENCE TO RELATED APPLICATION

The present application claims the benefit of previously filed co-pending Provisional Patent Application, Ser. No. 62/217,078, filed on Sep. 11, 2015.

### FIELD OF THE INVENTION

The device of this disclosure belongs to the field of manufacture of spectrometer filters. More specifically it is a new Pulsed Xenon light source suppression filter for spectrometry applications.

### BACKGROUND OF THE INVENTION

Pulsed Xenon or “PX” sources are a great source of light for variety of Spectroscopic applications such as Absorbance, Reflection, and Fluorescence measurements. They produce light energy with a spectral range from approximately 220-750 nm. However, they inherently produce more intense light output in the range from 400-600 nm. This can present itself as a problem when a user desires to take measurements outside of this range. This is because the spectrometer can become saturated with the stronger visible light before the maximum signal can be obtained in the Ultra-Violet and Near Infra-Red regions of the spectrum.

To compensate for the above described “unbalanced” spectral output the following Xenon suppression filter design for spectrometry applications is disclosed.

### BRIEF SUMMARY OF THE INVENTION

This invention is a filter device for improving the suppression of light from a Pulsed Xenon light source for spectrometry by combining a Variable Longpass Order-Sorting filter with a Dichroic Balancing filter coated on a fused Silica substrate. The Dichroic Balancing filter is coated on the opposite side of the Variable Longpass Order-Sorting filter or combined with a second substrate. The substrate is made of fused silica to avoid any attenuation of signal in the UV regions.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a diagram of the Xenon Suppression Filter on one substrate; and,

FIG. 2 shows a diagram of the spectral response of the Xenon Suppression Filter.

### DESCRIPTION OF THE PREFERRED EMBODIMENT

As discussed the disclosed device improves the suppression of light from a Pulsed Xenon light source for spectrometry by combining a Variable Longpass Order-Sorting filter with a Dichroic Balancing filter by coating them both on a fused Silica substrate.

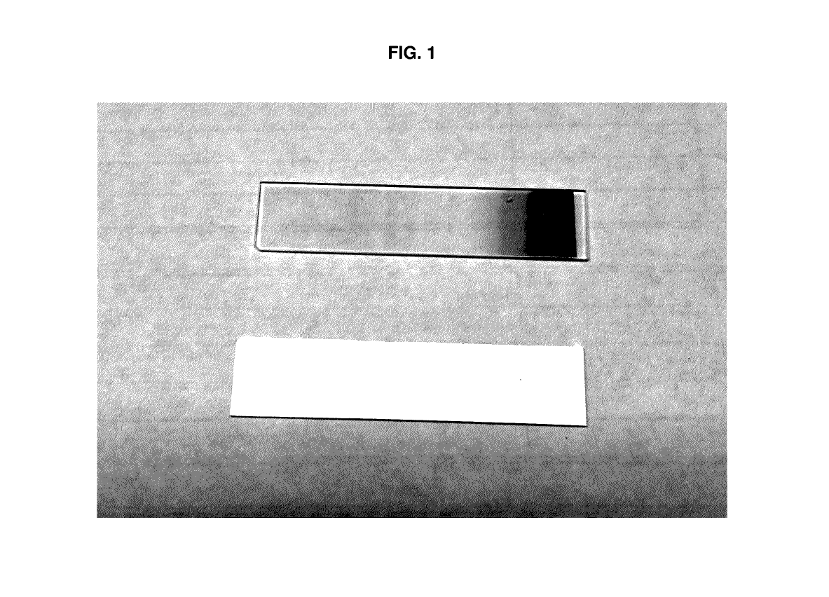

As shown in FIG. 1 a preferred embodiment of this device is constructed by coating the Dichroic Balancing filter (shown at bottom of FIG. 1) on the opposite side of the Variable Longpass Order-Sorting filter substrate (shown at top of FIG. 1), or, in an alternate embodiment, by combining the two filters using two substrates. The substrates are made of fused silica to avoid any attenuation of signal in the UV regions.

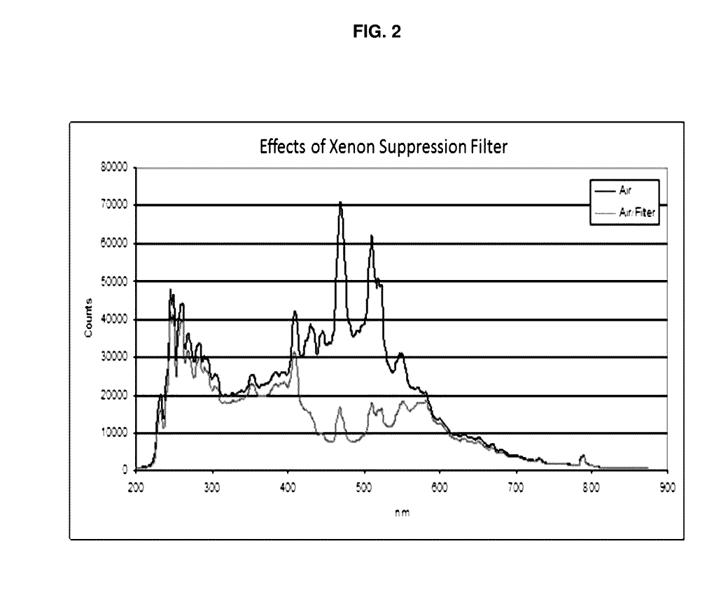

As shown in FIG. 2 the device of this disclosure suppresses the more intense light output in the range from 400-600 nm from the Pulsed Xenon light source.

Since certain changes may be made in the above described Xenon suppression filter without departing from the scope of the invention herein involved, it is intended that all matter contained in the description thereof or shown in the accompanying figures shall be interpreted as illustrative and not in a limiting sense.

What is claimed is:

1. A Xenon suppression filter comprising:
a Dichroic Balancing filter coated on one side of a fused Silica filter substrate; and,
a Variable Longpass Order-Sorting filter coated on the opposite side of said fused Silica filter substrate.

2. A Xeon suppression filter comprising:
a Dichroic Balancing filter coated on a first fused Silica filter substrate;
a Variable Longpass Order-Sorting filter coated on a second fused Silica filter substrate; and,
combining said first and second coated fused Silica filter substrates.
